(19) United States
(12) Patent Application Publication
(10) Pub. No.: US 2009/0220644 A1
(43) Pub. Date: Sep. 3, 2009

(54) MICROFOAMED FRESH DAIRY PRODUCT AND METHOD FOR MAKING SAME

(76) Inventors: Sophie Vaslin Nee Reimann, Saint Cloud (FR); Celine Valentini, Chatillon (FR); Catherine Schorsch, Boulogne-Billancourt (FR); Jerome Casalinho, Paris (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/091,358

(22) PCT Filed: Oct. 26, 2006
(86) PCT No.: PCT/EP06/67813

§ 371 Date: Aug. 5, 2008

(30) Foreign Application Priority Data
Oct. 26, 2005 (FR) 0510928

(51) Int. Cl. A23C 13/12; A23G 3/52; A23C 9/12

(52) U.S. Cl. 426/41; 426/570; 426/474; 426/442

(57) ABSTRACT

The invention concerns a microfoamed fresh dairy product containing native defatted soluble seric proteins and microcrystalline cellulose, the overrun being less than 20%, the average diameter of the bubbles being less than 200 μm and the microfoamed fresh dairy product being stable for a period ranging between 12 days and 6 weeks, at a temperature between 1 and 10° C. The invention also concerns a method for making same.

The present invention relates to a stable microfoamed fresh dairy product and to its preparation method.

Foamed food systems are complex, because they consist of various dispersed phases in a continuous aqueous medium and/or of lipid phases such as oil droplets, air bubbles, crystals of sugar or fat. In order to guarantee robustness of the formulations from an industrial point of view, while maintaining good organoleptic properties of these foams, particular attention is paid to the formulation in order to facilitate foamability of the foam and to guarantee its stability over time.

Microfoaming consists of injecting a very small amount of air (<20% by volume, preferably <10% by volume, still better=5% by volume) in order to obtain bubbles with very small particle size, quasi invisible to the naked eye: less than 200 μm. This microfoaming does not have the purpose of modifying the macroscopic texture of the yogurt, as may do conventional foaming which consists of injecting 50 to 100% by volume of air. On the other hand, the advantage of this technology is to change the sensorial properties of the yogurt without the consumer detecting it visually. The benefit is to provide a sort of signature of the yogurt, allowing it to be differentiated.

Among the ingredients used in making foams, the role of the emulsifiers is determining in the foam forming processes, whereas that of the stabilizers will essentially be involved in stabilizing the latter during its lifetime. Now, dairy products containing very small amounts of fat form stable foams with difficulty.

Gelatin occupies a place of choice among stabilizers and emulsifiers, considering its multifunctional properties: in aerated systems, it plays two fundamental roles by acting as a foaming agent and by then allowing stabilization of the aerated texture. However, its use is regularly questioned for questions of food safety (BSE problem) or religious questions. Now, its replacement is not simple.

The choice of the emulsifier is important as it conditions the foamability of the dairy base. Most customary emulsifiers such as fatty acid mono-diglycerides may be suitable, but they have the drawback of providing the finished product with fat, which is incompatible with low-fat yogurts.

Surprisingly, the inventors discovered that <<defatted >> and native (i.e. non-denatured as are the byproducts of the cheese industry) seric proteins, free of fat, as obtained by a microfiltration or ion chromatography exchange method, are excellent candidates for microfoaming of dairy products, in particular acid, advantageously low-fat products, either fermented or not.

Of course it is known from patent applications WO02/060283, WO03/053174 and EP1284106 how to foam dairy products with proteins which are slightly or not denatured. However, in the case of patent applications WO02/060283 and WO03/053174, the microbubbles are made and dried before their incorporation into a dairy product. Further, the inventors of the present application noticed surprisingly that in the case when seric proteins are used as foaming agent, a stabilizer has also to be used in order to keep a microfoamed product stable and to thereby avoid an increase in the size of the bubbles. After multiple investigations, the inventors discovered that the desired stabilization may only be obtained with microcrystalline cellulose (MCC) while remaining compatible with the proteins used and being simple to apply. Indeed, MCC has the particularity of being insoluble, its functionalization being provided by activation, i.e. strong shearing. With the structure induced by MCC, the microbubbles may be stabilized until the expiry date (DLC) for consuming the product while avoiding any destabilization phenomenon such as Oswald ripening or coalescence.

The present invention therefore relates to a microfoamed fresh dairy product containing native defatted soluble seric proteins and microcrystalline cellulose, the overrun being less than 20%, the average diameter of the bubbles being less than 200 μm and the microfoamed fresh dairy product being stable for at least a period ranging between 12 days and 6 weeks, at a temperature between 1 and 10° C.

In the sense of the present invention, the term of “microfoaming” means the injection of a very small amount of gas (<20% by volume, preferably <10% by volume, advantageously=5% by volume) in order to obtain after foaming, bubbles with a very small particle size, quasi invisible to naked eye: the average diameter of the bubbles being less than 200 μm. Advantageously, the injected gas is traditionally selected from air and nitrogen, but it may also contain nitrous oxide (N₂O) or CO₂.

In the sense of the present invention, the term “microfoamed product” means the product obtained as a result of the microfoaming according to the present invention.

Thus, the overrun of a microfoamed product according to the present invention is <20%, preferably <10%, advantageously=5%.

The overrun is computed in the following way:

$$Overrun = \frac{( \begin{matrix}Pot mass with unfoamed product - \\ Pot mass with foamed product\end{matrix} )}{( Pot mass with unfoamed product )} \times 100$$

The average diameter of a bubble D_{3,2} fits the following equation:

D_{3,2}=sum(i=1 to n)dᵢ³/sum(i=1 to n)dᵢ²

Advantageously, the average diameter of the bubbles is comprised between 50 and 200 μm, advantageously comprised between 90 and 150 μm, still more advantageously comprised between 80 and 100 μm.

In the sense of the present invention, the term of “native” describes any protein which is not or very slightly denatured (the denaturation level of a protein may be calculated by the quantification of the percent of seric protein not solubilized at its isoelectric pH). Therefore, these are not byproducts of the cheese industry. Further, the heat treatment which is applied to them if necessary should be conducted at a temperature which does not cause denaturation of these proteins and for a sufficient but limited time. Advantageously, the defatted soluble native seric proteins are obtained by a heat-free method for demineralizing and/or ultrafiltering and/or microfiltering milk or by a chemical or enzymatic treatment of milk. With these methods, the natural quality and the bioactivity of the obtained seric proteins may be preserved. Advantageously, the denaturation level of the seric proteins is less than 5%, advantageously less than 2%, still more advantageously it is about 1%. Advantageously, the seric proteins according to the present invention contain at least 50% by weight of beta-lactoglobulin, advantageously 57% by weight and advantageously less than 20% by weight of α-lactalbumin, advantageously 18% by weight. In the sense of the present invention, the term of “defatted” describes any protein containing less than 1% by weight of fat, advantageously less than 0.5% by weight, advantageously about 0.4% by weight.

Advantageously, these defatted soluble native seric proteins originate from isolates of defatted soluble native seric proteins, for which the defatted native soluble seric protein content is advantageously larger than 80% by weight, advantageously larger than 90% by weight. Advantageously, these isolates contain very little lactose, advantageously less than 10% by weight, advantageously less than 4% by weight, still more advantageously about 3% by weight.

Advantageously the isolates of defatted soluble native seric proteins are Prolacta 90 marketed by Lactalis, Ultra whey-99 marketed by Volactive or Promilk 852 FB marketed by Ingredia.

Advantageously, the microfoamed fresh dairy product according to the present invention contains from 0.08 to 3% by weight of defatted native soluble seric proteins based on the total weight of the dairy product, advantageously from 0.09 to 3% by weight of defatted native soluble seric proteins, based on the total weight of the dairy product, still more advantageously between 0.1% and 3% by weight of defatted native soluble seric proteins based on the total weight of the dairy product.

Any dairy product contains seric proteins. However, they are often mostly denatured as a result of pasteurization, sterilization and/or fermentation of the dairy product. Now, this denaturation reduces the foaming power of these proteins. Finally, the present amounts are not sufficient for foaming the dairy product. It is therefore appropriate to add some more amounts.

In a particular embodiment, the microcrystalline cellulose is stabilized, advantageously by a protective colloid. Advantageously, the protective colloid is not carboxymethylcellulose. Advantageously, the protective colloid is pectin. In particular, this is microcrystalline cellulose stabilized by Avicel pectin (trade name reference Avicel XP 3602) marketed by FMC.

Advantageously, the microfoamed fresh dairy product according to the present invention contains from 0.3 to 5% by weight of stabilized microcrystalline cellulose based on the total weight of the dairy product, advantageously between 0.3 and 3% by weight of stabilized microcrystalline cellulose based on the total weight of the dairy product.

In the sense of the present invention, a “dairy product” or “dairy base” means any acid or neutral dairy product or dairy base and therefore any dairy product or dairy base fermented or acidified via ingredients (advantageously by lactic, citric or phosphoric acid) with an acid (advantageously its pH is less than 4.8, advantageously it is comprised between 3 and 4.8) or neutral pH (advantageously its pH is comprised between 4.8 and 7.3, advantageously between 5.5 and 6.8). In particular, this may be fresh cheese or a fermented product containing living ferments (for example acid cream, kefir, or other products) and notably a yogurt or assimilated fermented dairy specialties (fermented by lactic bacteria, such as active bifidus or L. casei). Within the scope of the present invention, acid dairy products or dairy bases, advantageously fermented, advantageously of the yogurt type, will be preferred. Advantageously, this is a yogurt of the stirred type. Advantageously, the product or the base is fermented by adding living ferments such as for example Lactobacillus bulgaricus, Streptococcus thermophilus and/or Lactobacillus acidophilus and/or bifidus.

Advantageously, the milk used in the dairy product or dairy base is cow milk. However, other milks may be used as a total or partial substitution for cow milk, such as for example goat, ewe, buffalo cow or mare milk, or less advantageously milks of plant origin such as soya, coconut or oats milk.

The pasteurized or sterilized acid or neutral dairy base or dairy product and optionally fermented, is obtained according to methods well known to one skilled in the art. In particular, the method for obtaining a fermented pasteurized acid dairy product or dairy base comprises the following successive steps:
homogenization of the dairy base or dairy product,
pasteurization of the dairy base or dairy product,
cooling the dairy base or dairy product,
sowing,
fermentation until the desired acidity is obtained.

Briefly, the method begins with raw milk which may also contain a combination of full milk, skimmed milk, condensed milk, dry milk (a defatted dry milk extract or equivalent), category A lactoserum, cream and/or other milk fraction ingredients such as for example buttermilk, lactoserum, lactose, or lactoserum modified by partially or totally removing the lactose and/or minerals or other dairy ingredients in order to increase the defatted solid contents, which are mixed in order to provide the desired fat and solid contents. Although not preferred within the scope of the present invention, the dairy product or dairy base may contain a dairy filling component, i.e. a dairy ingredient for which one portion is formed by a non-dairy ingredient, such as for example an oil or soya milk.

Advantageously, the microfoamed fresh dairy product according to the present invention may either contain fat or not, i.e. from 0 to 15% by weight, advantageously from 0 to 5% by weight of fats based on the total weight of the dairy product.

Advantageously, the microfoamed fresh dairy product according to the present invention does not contain any gelatin.

In a particular embodiment of the invention, the microfoamed fresh dairy product according to the present invention contains other ingredients, advantageously selected from sweet syrups, cream, fruit preparations such as fruit pulp, fruit puree or pieces of fruit, and cocoa.

The microfoamed fresh dairy products according to the invention have the organoleptic evasive, light and covering properties.

Further, microfoaming of the dairy products according to the present invention enhances the sweet taste of this dairy product. Thus, advantageously, the microfoamed fresh dairy product according to the present invention may contain lower sugar content as compared with non-microfoamed dairy products, advantageously 1 to 10% less sugar contents by weight-relatively to the total weight of the non-microfoamed dairy product.

Further, the microfoamed acid dairy products according to the present invention have a less acid and less astringent taste than non-microfoamed products, the sweet and light caramel flavors being more enhanced.

Further, in the case when the microfoamed fresh dairy products according to the present invention contain fruit preparations, the tastes of esterified fruit and acetaldehydes are reduced. Finally, if the fruit preparations contain large pieces of fruit, the latter and in particular their firmness are more enhanced on the dairy base as compared with fresh non-microfoamed dairy products.

The present invention further relates to a method for preparing a microfoamed fresh dairy product according to the present invention, the method comprising the following successive steps:

a) formulating a dairy base comprising native defatted soluble seric proteins, advantageously as isolates, and microcrystalline cellulose;

b) microfoaming this dairy base, and

c) recovering the microfoamed fresh dairy product.

A static foaming device may be used during step (b) of the method according to the present invention. Its drawback is the larger destructuration of the dairy base during the application of this step by using such a foaming device. Further, the bubbles obtained by this type of foaming device are of course of smaller sizes but less stable.

Thus, advantageously, step (b) is carried out by means of a dynamic foaming device, for example of the Mondomix type.

In a first advantageous embodiment, step (a) of the method according to the present invention consists in mixing a dairy base with a non-foamed foaming aqueous solution containing native defatted soluble seric proteins and microcrystalline cellulose.

Advantageously, during step (a), 5 to 15% by weight of foaming aqueous solution is added to 95 to 85% by weight of dairy base, advantageously 10% by weight of foaming aqueous solution is added to 90% by weight of dairy base.

In this first embodiment, advantageously, the microfoamed fresh dairy product obtained in step (c) comprises between 0.3 and 3% by weight of microcrystalline cellulose based on the total weight of the dairy product.

Advantageously, in this first embodiment, the foaming aqueous solution contains ingredients selected from sweet syrups, cream, fruit preparations, such as fruit pulp, fruit puree or pieces of fruit, and cocoa.

However, it is also possible that the other ingredients selected from the sweet syrups, cream, fruit preparations, such as fruit pulp, fruit puree or pieces of fruit, and cocoa are not present in the aqueous foaming solution and are added and mixed with the microfoamed dairy product according to the present invention via an additional step (d).

Advantageously, in this first embodiment of the method according to the present invention, this method comprises a preliminary step (α) of preparing the foaming aqueous solution by mixing, advantageously under strong stirring, the ingredients in water without incorporating air, followed by acidification, advantageously by citric acid or malic acid and advantageously up to a pH comprised between 4 and 4.8, heat treatment advantageously at a temperature of 60 to 72° C. for 10 to 1 min, and homogenization of the obtained mixture, advantageously at a pressure comprised between 3.10⁶ Pa and 10.10⁶ Pa.

Advantageously, the mixture of the ingredients in water is followed by a hydration step, advantageously for a period ranging between 30 min and 1 hour, after the acidification step.

Advantageously, the foaming aqueous solution contains between 5 and 10% by weight of microcrystalline cellulose, advantageously 6% by weight, based on the total weight of the foaming aqueous solution.

Advantageously, the foaming aqueous solution contains between 2.4 and 10% by weight of defatted soluble native seric proteins, advantageously 5.5% by weight of seric proteins based on the total weight of the foaming aqueous solution. Advantageously, the seric proteins exist as isolates.

Advantageously, within the scope of this first embodiment, the dairy base is fermented and fermentation takes place before the step (a) of mixing the dairy base and the foaming aqueous solution.

Advantageously, the mixing steps (a) between the dairy base and the foaming aqueous solution and (b) microfoaming steps are carried out simultaneously in a single step.

The advantage of this first embodiment is not to lose the yogurt label.

In a second embodiment, step (a) of the method according to the present invention, consists in adding soluble native defatted seric proteins as a powder, advantageously as a powder of isolates and microcrystalline cellulose as a powder and mixing them with the dairy base. Advantageously, the soluble native seric proteins and microcrystalline cellulose are added simultaneously or separately before heat treatment and fermentation, as a powder into the dairy base.

Advantageously, the dairy base is fermented and the microcrystalline cellulose is added before the fermentation step of the dairy base, the defatted soluble native seric proteins being added after the fermentation step.

Thus, advantageously, fermentation takes place before introducing native defatted soluble seric proteins during the formulation step (a).

The advantage of this second embodiment, is that the yogurt is not diluted by adding an aqueous preparation, but that the amount of microcrystalline cellulose present in the obtained microfoamed dairy product will be larger than in the case of the first embodiment: (about 2-3% by weight as compared with about 0.6% by weight).

Advantageously, other ingredients selected from sweet syrups, cream, fruit preparations, such as fruit pulp, fruit puree or pieces of fruit and cocoa are added and mixed with the microfoamed dairy product according to the present invention via an additional step (d).

Advantageously, the additional step (d) is carried out by means of a dynamic mixer of the Dosys type.

In a third embodiment of the invention, the method for preparing a microfoamed fresh dairy product according to the present invention comprises the following successive steps of
(A) preparing a foaming aqueous solution containing the native defatted soluble seric proteins, advantageously as isolates and microcrystalline cellulose, water and a fruit puree;
(B) microfoaming this preparation;
(C) mixing the microfoaming aqueous preparation with a dairy base and
(D) recovering the microfoamed fresh dairy product.

Advantageously, the fruit puree of step (A) does not contain any pieces of fruit.

Advantageously, during this step (C), 5 to 15% by weight of foaming aqueous solution is added to 95-85% by weight of dairy base.

This third embodiment is simpler to carry out than the first two.

The method according to the present invention may comprise an additional step (e) of conditioning the microfoamed fresh dairy product obtained as a result of step (c), (d) or (D).

Control of the microfoaming method requires thorough knowledge of the parameters of the method, such as the homogenization pressure, the foaming temperature in connection with the formulation parameters, such as for example the concentration of defatted soluble native seric proteins and the nature of the microcrystalline cellulose.

The following examples are given as a non-limiting indication.

### EXAMPLE 1

### A Microfoamed Plain Yogurt with 0.07% by Weight of Fat According to the Present Invention

The method which was selected, consists of mixing 10% by weight of a foaming syrup containing the emulsifier and stabilizer with 90% by weight of the white mass, and of then foaming the set of both masses by means of a dynamic foaming device (Mondomix) before conditioning the thereby obtained microfoamed product. This, therefore, is the method according to the first embodiment of the present invention.

The tests are carried out at a pilot scale 110 L/h:

The syrup is obtained by mixing under strong stirring the protein and the MCC. The powders should be gently incorporated without incorporating air (MCC promotes formation of bubbles and their being maintained). It is also required to use a powdering tank provided with a deflocculating blade in order to ensure homogeneous dispersion in the initial mixture. The MCC “rods” are thus partially activated and suspended. Moderate shearing is therefore necessary.

Hydration of the powders is carried out for 1 hour. After 45 minutes of hydration, adjustment of the pH to 4.6 is carried out by acidification with a 50% citric acid solution. For a 100 L tank, 1 to 2 L of acid solution have to be provided. The syrup is then passed through a platform with a plate exchanger (heat treatment=72° C. for 1 minute). The method then comprises homogenization of the syrup at 50 bars. It is then possible to carry out the batch type heat treatment for example in a jacketed tank with which the required heat treatment may be carried out, and equipped with a sufficiently powerful disperser (of the Silverson type, providing stirring of the order of 2,000 rpm for 30 min).

This is the homogenization step which will allow MCC to be expressed at best for a heat treatment on a platform. Significant shearing is therefore necessary.

Optionally the heat treatment may be conducted batchwise, the homogenizer may then be replaced with a disperser.

The composition of the syrup is indicated in the following Table 1:

| Raw materials | Incorporation level by weight |
|---|---|
| MCC stabilized by pectin | 6.00% |
| Avicel XP 3602 | |
| Isolates of defatted | 5.56% |
| soluble native seric | |
| proteins (Prolacta 90) | |
| Dechlorinated water | 89.44% |
| Total | 100.00% |
| Dry extract (weight %) | 9.50 |
| Dairy proteins (weight %) | 5.00 |

The syrup is added to the white mass at room temperature.

The white mass consists in a traditional plain yogurt with 0.07% by weight of fat. It contains:
skimmed milk (0% fat)
skimmed milk powder (PLE)
ferments.

Finally the yogurt contains about 0.07% fat and 4.9% proteins (the milk containing 3.5% of them and PLE 35% of them).

The white mass is at a temperature of 10° C.

Dynamic foaming is produced with a mini Mondomix and has the following characteristics (test at a pilot scale):

produced flow rate=44 L/h;

head speed=240 rpm;

overrun=1.053 (5% air by volume);

Recovery under pressure of the microfoamed fresh dairy product (0.04.10⁶ Pa).

The obtained microfoamed product is characterized by optical microscopy and image analysis and by sensorial tests.

Optical microscopy is an easy means for observing whether the MCCs are well suspended.

Microfoaming is stable for at least 28 days. There is no substantial increase in the size of the bubbles.

A sensorial test was carried out on the obtained microfoamed product by comparing it with a standard product, i.e. non-microfoamed product.

In particular, it was found that microfoaming acts on the sensorial aspects of the product by enhancing sweetened notes. Indeed, the sweet taste is further enhanced on the microfoamed product as compared with a non-microfoamed product.

Moreover, the microfoamed product is significantly:
more free-running than the non-microfoamed product;
less tacky;
more foamy.

### EXAMPLE 2

### A Microfoamed Plain Yogurt with 0.07% by Weight of Fat According to the Present Invention Containing a Fruit Preparation

The product obtained according to Example 1, at the outlet of the foaming device should be kept in a tank under a pressure of 0.4 bars as this is custom practice for foamed products. Mixing the fruit is then carried out in a standard way on a Dosys for example.

A sensorial test was carried out on the microfoamed product by comparing it with the standard product, i.e. the non-microfoamed product.

Thus, from an aromatic point of view:

The obtained microfoamed product is less acid and less astringent than the standard product. With microfoaming, the sweet flavor as well as the light caramel taste for fruit aromas may be enhanced. MCCs also have the property of reducing the esterified fruit and acetaldehyde tastes. On the other hand, the lactoserum notes are also reduced.

### EXAMPLE 3

### A Microfoamed Plain Yogurt with 0.9% by Weight of Fat According to the Present Invention

The method used is the same as the one of Example 1. The compositions are also identical, except for that of the white mass.

Indeed this white mass consists in a traditional plain yogurt with 0.9% by weight of fat. It contains:
0.5 g/L skimmed milk
cream
PLE (skimmed milk powder)
a concentrate of milk proteins (Hyprotal 45)
rice starch for the pot and mouth texture.

This mass therefore contains 0.9% fat and a 5.3% protein content. The obtained results are identical with those of Example 1.

1. A microfoamed fresh dairy product containing Native defatted soluble seric proteins and microcrystalline cellulose, the overrun being less than 20%, the average diameter of the bubbles being less than 200 pm and the microfoamed fresh dairy product being stable for at least a period ranging between 12 days and 6 weeks, at a temperature between 1 and 10° C.

2. The microfoamed fresh dairy product according to claim 1, wherein the microcrystalline cellulose is stabilized advantageously by a pectin.

3. The microfoamed fresh dairy product according to claims 1, wherein the dairy product is an acid dairy product.

4. The microfoamed fresh dairy product according to claim 1, wherein it contains from 0.08 to 3% by weight of defatted native soluble seric proteins based on the total weight of the dairy product.

5. The microfoamed fresh dairy product according to claim 1, wherein it contains from 0.3 to 5% by weight of microcrystalline cellulose based on the total weight of the dairy product.

6. The microfoamed fresh dairy product according to claim 1, wherein it does not contain any gelatin.

7. The microfoamed fresh dairy product according to claim 1, wherein it contains other ingredients.

8. The microfoamed fresh dairy product according to claim 1, wherein the dairy product contains from 0 to 15% by weight, of fat based on the total weight of the dairy product.

9. A method for preparing a microfoamed fresh dairy product according to claim 1 wherein it comprises the following successive steps:
a) formulating a dairy base comprising the native defatted soluble seric proteins and microcrystalline cellulose;
b) microfoaming this dairy base
c) recovering the microfoamed fresh dairy product.

10. The method for preparing a microfoamed fresh dairy product according to claim 9, wherein step (a) consists in mixing a dairy base with a non-foamed foaming aqueous solution containing native defatted soluble seric proteins, and microcrystalline cellulose.

11. The method according to claim 10, wherein that the microfoamed fresh dairy product obtained in step (c) comprises between 0.3 and 3% by weight of microcrystalline cellulose based on the total weight of the dairy product.

12. The method according to claim 10, wherein the foaming aqueous solution contains ingredients selected from sweet syrups, cream, fruit preparations or cocoa.

13. The method according to claim 9, wherein it comprises the additional step (d) of adding and mixing into the microfoamed fresh dairy product an ingredient selected from sweet syrups, cream, fruit preparations or cocoa.

14. The method according to claim 9, wherein it comprises an additional step (e) of conditioning the microfoamed fresh dairy product.

15. The method according to claim 10, wherein it comprises a preliminary step (a) of preparing the foaming aqueous solution by mixing the ingredients in water without incorporating air, followed by acidification, heat treatment and homogenization of the obtained mixture.

16. The method according to claim 9, wherein the dairy base is fermented and wherein the fermentation takes place before the mixing step between the dairy base and the foaming aqueous solution or before introducing native defatted soluble seric proteins during the formulation step (a).

17. The microfoamed fresh dairy product according to claim 2, wherein the microcrystalline cellulose is stabilized by a pectin.

18. The microfoamed fresh dairy product according to claim 3, wherein the dairy product is a fermented acid dairy product.

19. The microfoamed fresh dairy product according to claim 18, wherein the dairy product is a yogurt.

20. The microfoamed fresh dairy product according to claim 7, wherein the other ingredient is selected from sweet syrups, cream, fruit preparation and cocoa.

21. The microfoamed fresh dairy product according to claim 20, wherein the fruit preparation is selected from fruit pulp and pieces of fruit.

22. The microfoamed fresh dairy product according to claim 8 wherein the dairy product contains from 0 to 5% by weight of fat based on the total weight of the dairy product.

23. The process according to claim 9 wherein step (b) is carried out by means of a dynamic foaming device.

24. The process according to claim 10 wherein the native defatted soluble seric proteins are in the form of isolates.

25. The process according to claim 15 wherein the acidification is carried out by means of citric acid.
